(19) United States
(12) Patent Application Publication
(10) Pub. No.: US 2014/0300083 A1
(43) Pub. Date: Oct. 9, 2014

(54) Protective Cover

(71) Applicant: Kevin Patrick Barklage, Virginia Beach, VA (US)

(72) Inventor: Kevin Patrick Barklage, Virginia Beach, VA (US)

(21) Appl. No.: 13/856,383

(22) Filed: Apr. 3, 2013

(51) Int. Cl. B60D 1/60

(52) U.S. Cl. CPC B60D 1/60
USPC 280/507

(57) ABSTRACT

The invention is to a protective cover for providing cushioned protection to a desired object. In preferred embodiments, the protective cover is comprised of an outer shell that is durable, and water and stain resistant. An inner portion of the cover is comprised of a soft and pliable material that is segmented either by axial slits, a radial opening, and/or a spiral shaped slit to allow enough free space to allow an object to be protected to be inserted therein. The design allows the protective cover to engage the desired object to be protected, while also allowing the cover to be easily removed without the needs of a separate mechanical fastener or attachment.

### BACKGROUND OF THE INVENTION

1. Field of Invention

The present invention includes embodiments described herein generally relating to protective devices. The protective devices find use in protecting trailer and tow hitches extending from any type of vehicle or trailer. These protective devices easily engage and disengage an object to be protected, specifically a tow hitch, so as to be capable of use on multiple vehicles and multiple hitch types that provides protection and durability while visually engaging anyone in the area of the inherent danger a hitch imposes on a passerby.

2. Description of the related art

Tow hitches are found on a number of vehicles. Tow hitches extend from the rear bumper, and are located at dangerous levels, whether at knee or shin level when the vehicle is on the ground, or at head level when the vehicle is suspended on a lift or in storage, running into the hitch can cause great bodily harm and injury. There is a need for a protective cover that can absorb impact, is durable, capable of being used on any type of hitch and is able to engage the hitch with enough strength to remain intact while the vehicle is in operation, as well as be easily and readily removed in order to place on another vehicle.

Tow hitch covers have been previously provided and include those seen in U.S. Pat. No. 3,596,926. These covers include a soft absorbent material but only cover the receiving ball, and would offer little to no protection from someone striking the trailer hitch arm.

Other tow hitch covers include those provided in U.S. Pat. No. 6,322,094 to Poe which slide over the Ball and also cover the trailer arm, but provide little protection from when the vehicle is suspended in the air. A passerby may still strike the bottom of the trailer arm or bolt for the receiving ball which is not protected by the cover of Poe et al. Another disadvantage of Poe et al. is the requirement of latches to secure the protective cover which adds another manufacturing step, as well as time and effort to apply and secure the protective cover.

There is a need in the art for a protective cover that engages a hitch cover, and protects passersby from harmful injury. The present invention provides a protective cover that covers the entire hitch and trailer arm assembly, while being easily and readily removed in order to place on other vehicles.

### BRIEF SUMMARY DISCUSSION OF INVENTION

For a further understanding and nature and objects of the present invention reference should be made to the following detailed description, taken in conjunction with the accompanying drawings, in which like elements are given the same or analogous reference numbers and wherein:

### LIST OF FIGURES

FIG. 1 is a drawing showing the protective cover of the instant invention.

FIG. 2 is a side view of the protective cover of FIG. 1.

FIG. 3: is a drawing showing an alternative embodiment of the protective cover of the instant invention.

FIG. 4a and 4b are drawings showing an alternative embodiment of the protective cover of the instant invention.

FIG. 5 is a drawing showing an alternative embodiment of the protective cover of the instant invention.

### DESCRIPTION OF THE PREFERRED EMBODIMENTS

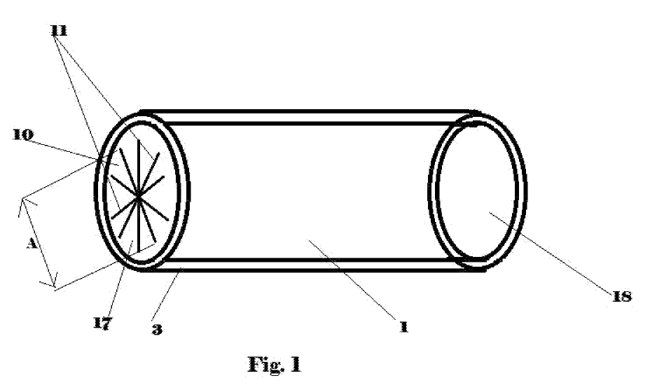

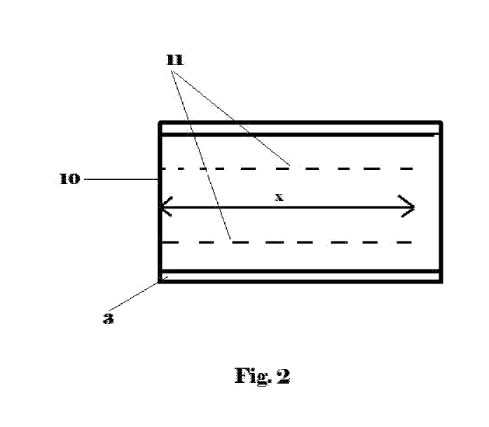

By way of example, referring to FIGS. 1 and 2, and in accordance with the present invention, a novel and improved protective cover for a bumper hitch is provided. The cover, 1, comprises two distal faces, 17 and 18, opposite of one another. These distal faces 17 and 18 are formed to have a predetermined shape, while distal faces 17, and 18, are exemplified in FIGS. 1 and 2 to be circular, it is understood that these distal faces may comprise any desired shape including polygonal shapes inclusive of squares, triangles, rectangles, circular, oval, or non polygonal shapes which are configured to receive a desired object. In preferred embodiments the distal faces 17 and 18 are circular shapes. The shape of the distal face, 17, is replicated along a longitudinal distance, extending the entire length of the cover, 1, and ending at the opposite distal face, 18, and therefore in the preferred embodiment, and as seen in FIGS. 1 and 2, a cover, 1, with a cylindrical shape is formed. While reference to cylindrical covers is made above, it is understood by a routineer in the art, that any three dimensional shape defined by the shape of the distal faces 17 and 18, may be used.

The cover comprises an interior portion 10. The interior portion, 10, is formed of a relatively soft foam material however can be any density foam desired, with low density foams being preferred. The interior portion, 10, is provided with a thickness that is determined based on the size of the hitch and trailer arm that is to be protected, as well as to allow for a desired amount of thickness to allow for protection. For a receiver that includes a receiver ball and hitch arm assembly with a height of 4 inches, the foam cover would preferably be at least 8 inches to allow for 2 inches of protection around each side of the arm. While 8 inches is described as a preferred embodiment, other thicknesses, include 10, 12, and 14 inches, and a shop or home can be equipped with multiple protective covers of different sizes to accommodate all types of vehicles. It is to be understood that the thickness of 8 inches is not the minimum thickness envisioned in this invention. The invention allows for smaller thicknesses, to include thicknesses only slightly higher than the height of the ball hitch and trailer arm assembly that is desired to be covered. In these cases high density foam would preferably be used to allow for greater protection with such a small thickness. The thickness of the interior portion is easily conceivable based on the desired application and the desired amount of protection based on the types of materials used for the inner portion, 10.

The interior portion comprises a plurality of axial slits or cuts, 11, provided therein. A “plurality” of axial slits is defined to mean that more than one slit, 11, is provided, and is inclusive of 2, 3, 4, 5, 6, 7, 8, 9, 10, or more slits, wherein the maximum number of slits is defined by technological capabilities. Each axial slit, 11, begins in distal face, 17, and extend a predetermined longitudinal distance, x, as seen in FIG. 2 into the inner portion, 10. In preferred embodiments the predetermined length, x, extends across a majority of the entire length of cover, 1, wherein a majority of the length includes greater than 50%, 60%, 70%, 80%, 85%, 90%, 95%, and 100% of the entire length of the cover, 1. It is more preferred that the axial slits 11, which start at distal face, 17, will terminate at a predetermined distance from distal face, 18, wherein it is preferred that the axial slits 11, terminate at a distance that is greater than 5%, 10%, 15%, 20%, 25%, of the entire length of cover, 1, from distal face, 18.

As seen in FIG. 1, the plurality of axial slits, 11, in distal face, 17, form slices with a predetermined width, A. The width, A, may extend through the entire distal face, 17, of protective cushion, 10, towards the outer exposed surface of the inner portion, 10, so that the inner portion, 10, comprises a plurality of individual pieces of the “pie”. In an alternative and most preferred embodiment the predetermined width, A, terminates before reaching an outer surface of the inner portion, 10, of the protective cushion. The axial slits, 11, provide the inner portion 10, with free space as well as the ability for the separate or integrated portions of the inner portion 10, defined by these axial slits, 11, to be deformed in order to allow for an object to be received therein.

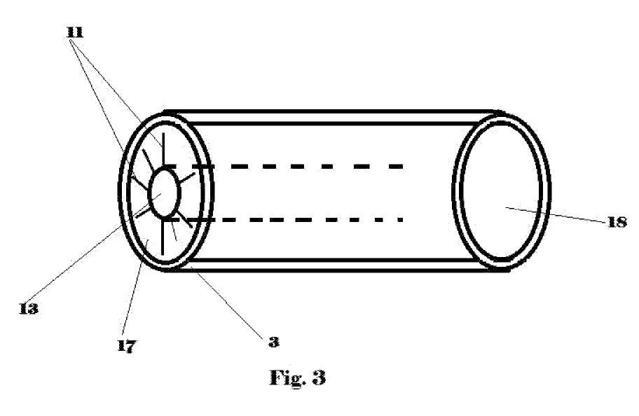

In an alternative embodiment, as seen in FIG. 3, the inner portion, 10, mentioned in FIG. 1 may further comprise a radial opening, 13, of a predetermined diameter and extending along a longitudinal plane, parallel to the axial slits, 11, to a predetermined length. The radial opening has a width and height that is sized appropriately in order to allow for a receiver ball of a trailer hitch to be received therein. An appropriate size is usually less than 2 inches but may be larger to accommodate larger receiver and trailer arm assemblies. The length of the radial opening 13, may or may not be equivalent to the length of the axial slits, 11 along the length of the inner portion, 10. Preferably the length of the radial opening 13, is within 25% of the distance of the length of the axial slits, 11, in order to provide strength to the inner portion, 10. The radial opening, 13, provides additional free space that in conjunction with the free space provided by the axial slits, 11, and the ability for the separate portions of the inner portion 10, defined by these axial slits, 11, to be deformed in order to allow for an object to be received therein.

In another preferred embodiment the radial opening, 13, is formed in the center of the distal face, 17, of the inner portion 10, however, the radial opening may be formed off center or in any location on the distal face, 17, desired. If the radial opening is offset, the user may face the area with more protective cushion towards the potential hazard. The offset portion may be on the upper end so that more protection from the cushion will be provided below and to the sides of the trailer hitch assembly which are areas of greatest concern when the trailer hitch assembly is located in high areas, such as on a vehicle on a lift or in a storage bay. Alternatively the offset portion may be used so that the protective cushion is provide with the greatest amount of cushion faces upwards, in order to provide greater protection when the trailer hitch assembly is located in low areas, such as on a vehicle on a lift or in a storage bay.

In an alternative embodiment, the protective cushion 1, further comprises an outer shell, 3, which surrounds at least a portion of the exterior surface of the inner portion 10. The outer shell, 3, is made of a material similar or different from the inner portion 10, and provides environmental protection from grease, oil, water, and grime, preferable materials include vinyl, however other materials include higher density foams, that would resist environmental hazards better than the inner portion, 10. The outer shell, 3, may be any color desired by the user, and may be provided with any logo or indicia desired. The protective cover can be used as a marketing tool to provide logos of companies thereon. In preferred embodiments the outer shell, 3, is formed of a bright color such as yellow, red, green or orange, and therefore functions to visually alert and warn users of its presence.

The thickness of the outer shell, 3, may be 0.01-100 mils, with preferred thicknesses including thicknesses of 1, 5, 10, 15, 20, 25, 30, 50, 75, 80, mils. While the thickness has been defined in preferred embodiment's the thickness is not limited to these thicknesses and can by any thickness desired, including thicknesses greater than 100 mils and is easily determined by the user in order to provide a certain degree of protection, durability, and strength to the inner portion 10, while taking into account cost effectiveness.

In one embodiment the outer shell, 3, provides a continuous and uninterrupted surface that extends around the entire outer surface of the inner portion, 10. A method of providing the continuous outer shell, 3, includes dip coating, slurry coating, spray coating etc. In other embodiments the outer shell material may be fabric or a hard rigid plastic or polymeric material that can be attached to the cover by known fastening means, such as known adhesive or mechanical fastening means.

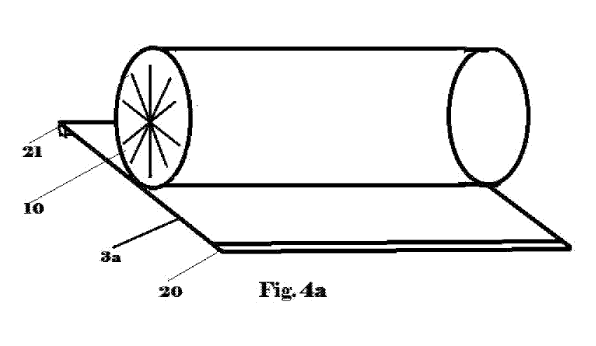

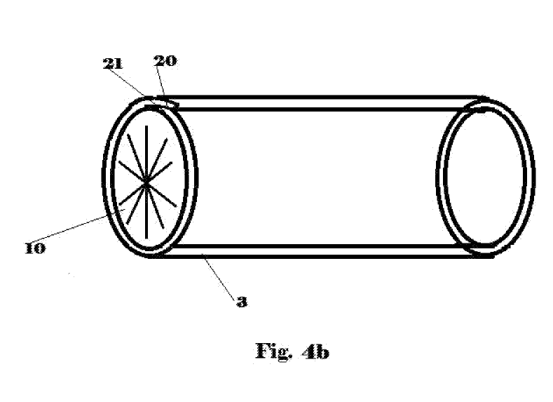

In an alternative embodiment the outer shell, 3, may be discontinuous. The discontinuous outer shell, 13, may still cover the entire exterior surface of the inner portion 10, as in the previous embodiment, however an edge is formed to make the surface of the outer shell 3, discontinuous. This can be seen in FIGS. 4a and 4b, where a rectangular piece, 3a, as seen in FIG. 4a, will form the discontinuous outer shell, and is wrapped around the protective cushion, 10 as seen in FIG. 4b, to form the outer shell 3. The rectangular form that is provided with a hook, 20, and loop, 21 fastening device on the edges to secure it around the protective cushion, 10, once the rectangular piece, 3a, is wrapped there around. By using this embodiment seen in FIGS. 4a and 4b, the outer shell, 3, of the protective cushion may be removed, washed and reattached without having to wash the interior portion. This allows longer life, as the outer portion will be the portion most exposed to environments including grease, oil, water, and road debris.

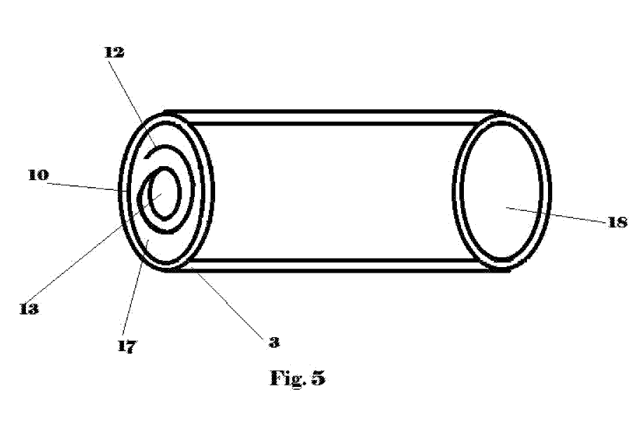

As seen in FIG. 5, in an alternative embodiment the axial cuts or slits, 11, of the embodiment shown in FIG. 1, are replaced with a spiral shaped slit, 12, that begins in distal face, 17, and extends a predetermined longitudinal distance, x, similar to the length of the slits seen in FIG. 2 into the inner portion, 10. In preferred embodiments the predetermined length, x, of the spiral shaped slit, 12, extends across a majority of the entire length of cover, 1, wherein a majority of the length includes greater than 50%, 60%, 70%, 80%, 85%, 90%, 95%, and 100% of the entire length of the cover, 1. It is more preferred that the axial slits 11, which start at distal face, 17, will terminate at a predetermined distance from distal face, 18, wherein it is preferred that the axial slits 11, terminate at a distance that is greater than 5%, 10%, 15%, 20%, 25%, of the entire length of cover, 1, from distal face, 18. The spiral shaped slit, 12, allows the user to twist the protective cover, 1, on and off of a desired object to be protected. The spiral also engages the object to be protected so that it is securely fastened. As in the case with the axial slits of FIG. 1, the spiral shaped design may also be provided with or without a radial opening, 13, of the same length and widths described in conjunction with the axial slits above.

The design of the axial slits 11, or the spiral shaped slit, 12, allows the protective cover, 1, to engage an object to be protected, and be snug against the object so that it will not fall off without a physical force exerted thereto. This design allows for a protective cover that is “self engaging” and will not require the need for external fastening means, which require higher manufacturing costs, as well as can fail overtime.

The protective covers described herein may also find applications in boat trailers to protect the ends of receiving hitches, or also in military applications. While preferred embodiments teach the use of the protective cover as a cover for a trailer hitch, the protective cover should not be limited to such end uses. The protective cover 1, may find alternative uses in protecting exhaust pipes, by engaging the exhaust tip of the muffler of a vehicle that is suspended on a lift. The protective cover may find use in protection from weight lifting devices, such as barbells. The protective cover may also be used as oversized koozies for wine bottles or champagne bottles. As can be envisioned by one of ordinary skill in the art, the protective cover finds many potential uses, such as oversized cozies for may find alternative uses in protecting A protective cover of any size and dimension, or shape, and such variations are anticipated by the invention and appended claims. While preferred embodiments of the foregoing have been shown and described it will be understood by one of routine skill in the art that the description is illustrative and not intended to limit the scope or purpose of the invention.

What is claimed is:

1. A protective cover comprising:
an inner portion comprising a length, a first distal face and a second distal face opposite the first distal face, wherein the inner portion comprises a plurality of axial slits that begin at said first distal face and extends along the length of the inner portion towards the second distal face, and
an outer shell that surrounds an outer surface of the inner portion.

2. The protective cover of claim 1, wherein the outer shell is made of a vinyl material.

3. The protective cover of claim 1, wherein the outer shell includes a hook and loop fastening device that extends along a length of the outer shell parallel to the length of the inner portion.

4. The protective cover of claim 1, wherein the plurality of axial slits have a length that is shorter than the length of the interior portion.

5. The protective cover of claim 1, wherein the inner portion further comprises a radial opening that begins at said first distal face and extends along the length of the inner portion towards the second distal face.

6. The protective cover of claim 5, wherein the radial opening has a length that is shorter than the length of the interior portion.

7. The protective cover of claim 1, wherein the axial slits have a width that is less than a width of the inner portion.

8. The protective cover of claim 1, wherein the inner portion is formed of foam.

9. A protective cover comprising:
an inner portion comprising a length, a first distal face and a second distal face opposite the first distal face, wherein the inner portion comprises a spiral shaped slit that starts at said first distal face and extends along the length of the inner portion towards the second distal face, and
an outer shell that surrounds an outer surface of the inner portion.

10. The protective cover of claim 9, wherein the outer shell is made of a vinyl material.

11. The protective cover of claim 9, wherein the outer shell includes a hook and loop fastening device that extends along a length of the outer shell parallel to the length of the inner portion.

12. The protective cover of claim 9, wherein the spiral shaped slit has a length that is shorter than the length of the interior portion.

13. The protective cover of claim 9, wherein the inner portion further comprises a radial opening that starts at said first distal face and extends along the length of the inner portion towards the second distal face.

14. The protective cover of claim 13, wherein the radial opening has a length that is shorter than the length of the interior portion.

16. The protective cover of claim 9, wherein the inner portion is formed of foam.
